(19) United States
(12) Patent Application Publication
(10) Pub. No.: US 2004/0226614 A1
(43) Pub. Date: Nov. 18, 2004

(54) Catastrophe avoidance system and method

(76) Inventor: James Raymond Lane, Raleigh, NC (US)

Correspondence Address: JINAN GLASGOW, P O BOX 28539, RALEIGH, NC, 276118539

(21) Appl. No.: 10/436,899

(22) Filed: May 13, 2003

(51) Int. Cl. G05D 7/06

(52) U.S. Cl. 137/487.5

(57) ABSTRACT

A system and method for managing household subsystems, including a controller having a microprocessor, a memory, and a power source; the controller connected to at least one sensor that is constructed and configured to monitor a catastrophic indicator relating to a corresponding at least one household subsystem; wherein one of the at least one household subsystems is an internal household plumbing system and wherein the catastrophic indicator is a flow sensor set to detect flow above about 0.4 gal/min for a predetermined time period, substantially immediately following which automatic deactivation of the internal household plumbing system by the controller is performed to prevent catastrophic flooding of the household.

### BACKGROUND OF THE INVENTION

(1) Field of the Invention

The present invention relates generally to household management systems and methods and, more particularly, to a water management system and method for catastrophic flooding avoidance.

(2) Description of the Prior Art

Prior art includes the following: U.S. Pat. No. 6,209,576 to Davis issued Apr. 3, 2001 for Automatic fluid flow shut-off device. This invention includes a fluid flow sensor, control panel housing, central processing unit, visual display panel, programming buttons, and indicator lights, and either a solenoid actuated fluid shut-off valve or relay to interrupts power to fluid pump. The sensor monitors fluid flow and outputs data to CPU, the CPU compares measured fluid flow value with preprogrammed value for particular operating conditions or active zone of system. When measured fluid flow valve exceeds applicable preprogrammed maximum value the CPU actuates solenoid to close shut-off valve. The device allows a homeowner to set fluid shut-off device to a mode where no fluid flow is allowed, for example when home is uninhabited for an extended period of time.

U.S. Pat. No. 6,105,607 to Caise, et al. issued Aug. 22, 2000 for Microprocessor controlled water shut-off device. This device uses flow sensor to detect unwanted water flow caused by appliance/plumbing failures by comparing flow with pre-set programs of time of day and duration of flow. If preset parameters are exceeded, it activates shut-off valve to minimize damage. The device is preprogrammed for water usage 24/7, is fully automatic after installation, and allows flexible programming.

U.S. Pat. No. 5,568,825 to Faulk issued Oct. 29, 1996 for Automatic leak detection and shut-off system. An automatic leak detection, alarm, and shut-off system for detecting unwanted flow in fluid supply, including small leaks. System may be operated in continuous mode or on a timed mode. System includes inflow sensor, discharge sensor, and valve means. Programmable control means allow activation/deactivation of system, operation of shut-off valve means/alarm means, setting of periodic time segments for system to be active/inactive.

U.S. Pat. No. 5,038,820 to Ames, et al. issued Aug. 13, 1991 for Automatic fluid shutoff system. Includes a power circuit, flow sensor, and shutoff valve, so that if continuous flow is detected for a time period exceeding a preselected time the shutoff valve will automatically close. Control circuit can be preset for different operational modes. Includes a low flow rate sensor to detect small leaks which can cause damage over time, provides ample power during power failure and has a low voltage shutoff, and shutoff may be preset for shorter period of time when home is vacant/unmonitored.

U.S. Pat. No. 5,004,014 to Bender issued Apr. 2, 1991 for Automatic fluid flow sensor and fluid shut-off system. System allows flow of water into a structure to be sensed, timed, and stopped when flow exceeds a preset time. System consists of flow-sensing valve with infrared emitter, infrared detector, electric valve, and an electronics control unit. When flow is sensed by the valve, the detector produces a flow-trigger signal applied to programmable timer in the unit, the timer begins countdown, and after time has elapsed, the unit produces a signal removing power that keeps the electric valve open, shutting off water supply. Preset times can be from 1 minute to 31 minutes. System can be applied in combination with existing security systems.

U.S. Pat. No. 5,287,884 to Cohen issued Feb. 22, 1994 for Water flow monitoring system for determining the presence of leaks and stopping flow in plumbing pipes. Includes a flow monitor mounted to pipe for sensing flow of water through pipe. A timer or accumulated volume meter is associated with flow monitor to determine when flow has continued for preselected period of time, and/or when amount of water has exceeded a preselected volume threshold.

U.S. Pat. No. 5,971,011 to Price issued Oct. 26, 1999 for Water shut-off valve and leak detection system. Includes a microprocessor containing a real time clock, day of week indicator, and an elapsed time clock. Information is supplied to microprocessor to determine maximum allowable quantity of water that may flow over a specified period of time. The elapsed time clock is reset whenever the flow rate becomes zero or when the predetermined period of time is exceeded prior to predetermined flow quantity. If the flow quantity is exceeded with the allowable time frame, a solenoid is energized and moves a plunger that interrupts flow of water through the valve.

U.S. Pat. No. 5,409,037 to Wheeler, et al. issued Apr. 25, 1995 for Automatic device for the detection and shutoff of excess water flow in pipes. An automatic programmable water shutoff device for stopping the flow of excess water in plumbing pipes, comprises a detachable acoustic flow sensor (microphone) which is placed externally on existing plumbing pipe, a detachable valve actuator with high torque motor to attach to existing plumbing pipe valve stem, and a microprocessor based control circuit which monitors state of flow sensor, provides operator control interface, determines excess water flow conditions, and provides output signal to high torque motor which shuts off water during excess flow conditions.

U.S. Pat. No. 5,086,806 to Engler, et al. issued Feb. 11, 1992 for Automatic control system and flood protector. Includes a flow meter which emits a signal containing information about the flow and indicates when fluid is/is not flowing. A preferred metering device emits pulses at a rate proportional to flow rate. A counter accumulates a pulse count during each period of fluid flow; the accumulated pulse count is proportional to quantity of fluid passing through meter. Counter is set to close solenoid valve when predetermined maximum pulse count is exceeded.

U.S. Pat. No. 5,709,239 to Macalello, et al. issued Jan. 20, 1998 for Automatic shut-off safety device. A compact, automatic, mechanical fluid shut-off device which can detect a sustained leak in a pipe as well as a pipe burst and automatically shuts off fluid flow in the pipe.

U.S. Pat. No. 5,377,529 to Boyd issued Jan. 3, 1995 for Leak detecting device and method of constructing and utilizing same. A system for monitoring fluid flow in a water supply for leak detection; includes fluid flow sensor and monitors a series of pulses relating to fluid flow over a time period.

The prior art teaches away from monitoring flow/no flow status, except Ames, which teaches the measurement of continuous flow over time to prevent and stops flow if continuous flow exceeds a predetermined time duration. However, none of these prior art inventions strictly looks at no flow status during away periods. These prior art systems are thus too complex for persons unskilled in the art to operate on a sporadic basis. What is needed is a simple system that will recognize a catastrophic break in a subsystem during an away period, is simple and intuitive to operate, and can be easily overridden.

### SUMMARY OF THE INVENTION

The present invention is directed to a system for managing household subsystems, including a controller having a microprocessor, a memory, and a power source; connected to at least one sensor that is constructed and configured to monitor a catastrophic indicator relating to a corresponding at least one household subsystem; wherein one of the at least one household subsystems is an internal household plumbing system and wherein the catastrophic indicator is a flow sensor set to detect flow above about 0.4 gal/min for a predetermined time period, substantially immediately following which automatic deactivation of the internal household plumbing system by the controller is performed to prevent catastrophic flooding of the household.

The present invention is further directed to a method for preventing damage from catastrophic failure of household subsystems, including the steps of providing a controller having a microprocessor, a memory, and a power source, the controller being connected to at least one sensor that is constructed and configured to monitor a catastrophic indicator relating to a corresponding at least one household subsystem; wherein one of the at least one household subsystems is an internal household plumbing system and wherein the catastrophic indicator is a flow sensor set to detect flow above about substantially zero for a predetermined time period, substantially immediately following which automatic deactivation of the internal household plumbing system by the controller is performed to prevent catastrophic flooding of the household; monitoring the household subsystem by the controller through the sensors; detecting a flow above about 0.4 gal/min for a predetermined time period; automatically deactivating the household subsystem substantially immediately following the detection of said flow, thereby preventing catastrophe.

Accordingly, one aspect of the present invention is to provide a system for managing household subsystems, including a controller having a microprocessor, a memory, and a power source; connected to at least one sensor that is constructed and configured to monitor a catastrophic indicator relating to a corresponding at least one household subsystem; wherein one of the at least one household subsystems is an internal household plumbing system and wherein the catastrophic indicator is a flow sensor set to detect flow above about 0.4 gal/min for a predetermined time period, substantially immediately following which automatic deactivation of the internal household plumbing system by the controller is performed to prevent catastrophic flooding of the household.

Another aspect of the present invention is to provide a method for preventing damage from catastrophic failure of household subsystems, the method steps including providing a controller having a microprocessor, a memory, and a power source, the controller being connected to at least one sensor that is constructed and configured to monitor a catastrophic indicator relating to a corresponding at least one household subsystem; wherein one of the at least one household subsystems is an internal household plumbing system and wherein the catastrophic indicator is a flow sensor set to detect flow above about substantially zero for a predetermined time period, substantially immediately following which automatic deactivation of the internal household plumbing system by the controller is performed to prevent catastrophic flooding of the household; monitoring the household subsystem by the controller through the sensors; detecting a flow above about 0.4 gal/min for a predetermined time period; automatically deactivating the household subsystem substantially immediately following the detection of said flow, thereby preventing catastrophe.

These and other aspects of the present invention will become apparent to those skilled in the art after a reading of the following description of the preferred embodiment when considered with the drawings.

### BRIEF DESCRIPTION OF THE DRAWINGS

FIG. 1 is a schematic view of a water catastrophe avoidance system constructed according to the present invention.

FIG. 2 is a cut-away view of a module constructed according to the present invention.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

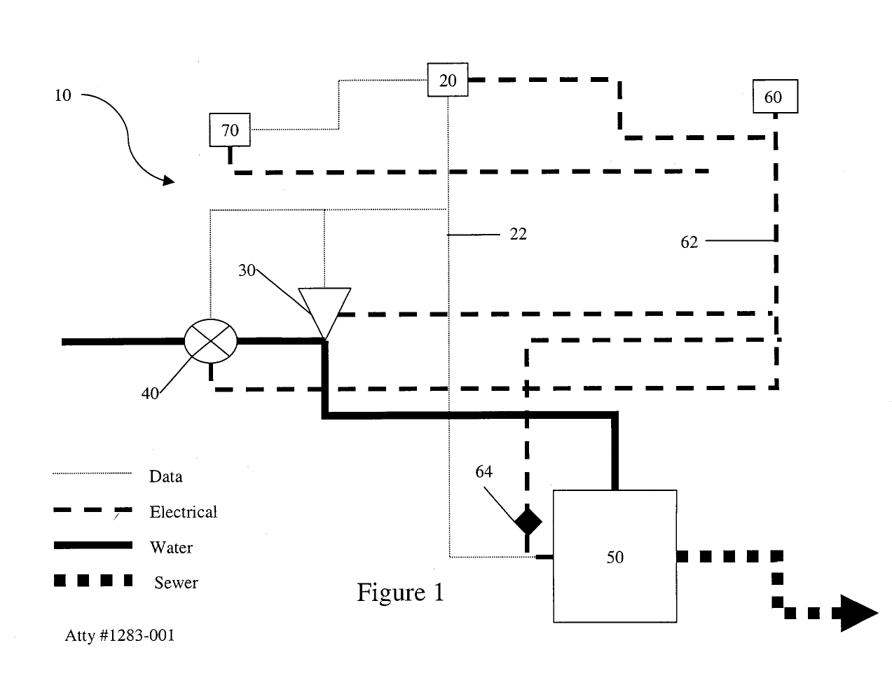

Referring now to the drawings in general, the illustrations are for the purpose of describing a preferred embodiment of the invention and are not intended to limit the invention thereto. As best seen in FIG. 1, the catastrophe avoidance system according to the present invention, generally referenced as 10, includes a management center 20, at least one sensor 30, at least one remotely-operative device 40, and at least one appliance 50, all in communication via data lines 22.

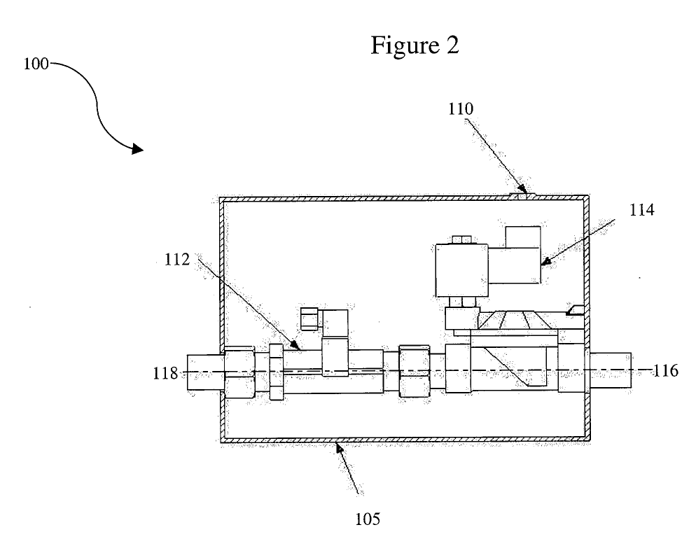

At least one subsystem is a plumbing system, and for this subsystem the at least one sensor is at least one flow sensor, the at least one remotely operative device is a water valve, and the at least one appliance is a water-using appliance. The plumbing subsystem module, generally described as 100 in FIG. 2, includes a casing 105, a flow sensor or switch 112, a remotely operative shut-off valve 114, an electrical connection point 110, a water inlet 116, and a water outlet 118. The water valve is upstream of the flow sensor, the flow sensor and shut-off valve are in electrical connection with the electrical connection point (not shown), and the household management center is in electrical connection with the flow sensor and water valve via the electrical connection point. The flow sensor is set to detect flow above about substantially zero gallons/minute, preferably above about substantially 0.4 gallons/minute, for a predetermined time period, substantially immediately following which the controller signals the water valve to shut down, thereby preventing catastrophic flooding of the household. The valve has a default off position, which shuts off water flow in the event of a power outage. The valve has a bypass screw that permits the user to open the valve in the event of a power failure without a catastrophic event to the plumbing subsystem.

The household management center may be positioned by a major water-using appliance, such as in the laundry or by the dishwasher, such that the user can reset the automatic shut-off if necessary to perform a water-intensive chore.

The household management center includes a computer with at least one clock, at least one user programmable microprocessor, a memory with software programs, and a power supply.

The programmable microprocessor includes a time period selection function, such that a maximum time period of functionality can be selected. For the plumbing subsystem, the functionality is uninterrupted flow above a predetermined flow rate and duration. For example, the flow sensor set to detect flow above about substantially zero flow for a time period of from between about 30 seconds and about 30 minutes can be set, such that if uninterrupted flow above a minimum level occurs for longer than this time period, the system shuts down the subsystem. This level of sensitivity permits detection of a catastrophic event, such as a broken pipe, but does not shut down a subsystem for poor performance, such as a leaky pipe. For example, the water flow sensor can be set to detect flow above about 0.4 gal/min for a predetermined time period, substantially immediately following which automatic deactivation of the internal household plumbing system by the controller is performed to prevent catastrophic flooding of the household.

The software programs include pattern recognition software designed to allow normal use. Excessive use indicates a potential problem with a subsystem. The programs are designed to stop the subsystem if use exceeds the allowable demand. A subsystem shutdown, such as a water shut-off, alerts the occupant that a problem exists. Thus, the system is an active alert system, and ensures that the occupant will not miss any deviations from the allowable demand.

These patterns programs can also be learned by the system. The system includes appropriate neural network software that can learn from observation. The system is placed in “learn” mode for a period of time, such as 2-3 weeks, and then switched to “control” mode. During the learning period, the system records daily and weekly usage, and generates a pattern of use. The day can be divided into several periods, including nighttime, early morning, early morning, mid-morning, lunchtime, afternoon, evening, weekends. For example, a nighttime program that allows maximum water flow for a reduced period of time allows use of the toilet and faucets at night.

The household management center can be integrated with other alarm systems 70, such that these alarms are activated whenever the system detects a catastrophic event. For example, in the event of catastrophic status in the plumbing subsystem, the center will notify a plumber or other competent person if the autoshutoff is not reversed within a specified period of time.

In reference to the plumbing subsystem, this subsystem includes at least one flow sensor connected to the primary water incoming water line. This sensor determines the total flow coming into the water system. The sensor signals the flow volume to the center. The plumbing subsystem also includes at least one remotely operative water valve in-line with the primary incoming water line and upstream from the flow sensor. The valve has a default off position, which shuts off water flow in the event of a power outage. The valve has a bypass screw that permits the user to open the valve in the event of a power failure without a catastrophic event to the plumbing subsystem.

The household management system is also connected via data transmission to at least one appliance, such that the appliance can signal to the center whenever it is turned on, thereby preventing the center from switching off a subsystem when the appliance is operating normally. For example, the water supply is not switched off when an appliance such as a dishwasher or washing machine is operating and using the water supply. In the event of a catastrophic water failure, the center can also switch off any appliances that are damaged by a water shut-off, such as water heaters and the like.

The system data communication can be accomplished using a variety of networking technologies, including data cables, wireless transmission, and/or powerline networking. Powerline networking is also known as X10 technology.

An example of powerline networking is the PowerPacket technology by Intellon, Inc. of Ocala, Fla. Powerline networking technology allows the user to quickly integrate all appliances, sensors, and valves with the household management center, because the powerline networking technology permits data transmission to the center through the electrical power circuit 60 and electrical control panel 62 using a controller 64.

Wireless networking, an example of which is Wi-Fi networking, can be used to connect the components of the system without the need for physical data cables.

The networking technology can also integrate appliances to another computer, such as one connected to the Internet via a cable modem, such that the system can be accessed through the Internet and/or direct telephone link. Such a feature would allow a person to remotely check the status of the household management system.

Additionally, the networking technology permits the user to override water shut-off by signaling to the center from any appliance. The user no longer needs to go to the center to reset the shut-off switch.

The present invention is thus a hybrid system that can distinguish between non-electrical water appliances, such as faucets and toilets, and electrical water appliances, such as dishwashers and washing machines.

By distinguishing between the two types of appliances, the system can monitor the maximum non-electricity-associated flow and the maximum electricity-associated flow, thereby allowing the system to learn the characteristics of system users and not shut down the water system when a programmable appliance is scheduled to run at an unusual time, for example during non-peak hours to take advantage of electricity provider discounts.

Thus, the present invention provides a system for managing household subsystems, including a controller having a microprocessor, a memory, and a power source; connected to at least one sensor that is constructed and configured to monitor a catastrophic indicator relating to a corresponding at least one household subsystem; wherein one of the at least one household subsystems is an internal household plumbing system and wherein the catastrophic indicator is a flow sensor set to detect flow above about 0.4 gal/min for a predetermined time period, substantially immediately following which automatic deactivation of the internal household plumbing system by the controller is performed to prevent catastrophic flooding of the household.

The at least one household subsystem is selected from the group consisting of security, exterior plumbing, lighting, HVAC, surveillance, air quality, smoke detection, carbon monoxide detection, and combinations thereof.

The system and subsystems can be connected via data lines, the powerline network, wireless communication, and combinations thereof.

The predetermined time period can occur during a period programmed for non-use, such as when the user of the household is asleep and/or away from the dwelling either on a daily basis or for prolonged periods of time, such as during a vacation.

The present invention also provides a method for preventing damage from catastrophic failure of household subsystems, the method steps including providing a controller having a microprocessor, a memory, and a power source, the controller being connected to at least one sensor that is constructed and configured to monitor a catastrophic indicator relating to a corresponding at least one household subsystem; wherein one of the at least one household subsystems is an internal household plumbing system and wherein the catastrophic indicator is a flow sensor set to detect flow above about substantially zero for a predetermined time period, substantially immediately following which automatic deactivation of the internal household plumbing system by the controller is performed to prevent catastrophic flooding of the household; monitoring the household subsystem by the controller through the sensors; detecting a flow above about 0.4 gal/min for a predetermined time period; automatically deactivating the household subsystem substantially immediately following the detection of said flow, thereby preventing catastrophe.

For the method, the at least one household subsystem is selected from the group consisting of security, exterior plumbing, lighting, HVAC, surveillance, air quality, smoke detection, carbon monoxide detection, and combinations thereof.

The system and subsystems can be connected via data lines, the powerline network, wireless communication, and combinations thereof.

The predetermined time period occurs during a period programmed for non-use, such as when the user of the household is asleep and/or away from the dwelling either on a daily basis or for prolonged periods of time, such as during a vacation.

Certain modifications and improvements will occur to those skilled in the art upon a reading of the foregoing description. All modifications and improvements have been deleted herein for the sake of conciseness and readability but are properly within the scope of the following claims.

1. A system for managing household subsystems, comprising:
a controller having a microprocessor, a memory, and a power source;
connected to at least one sensor that is constructed and configured to monitor a catastrophic indicator relating to a corresponding at least one household subsystem; wherein one of the at least one household subsystems is an internal household plumbing system and wherein the catastrophic indicator is a flow sensor set to detect flow above about 0.4 gal/min for a predetermined time period, substantially immediately following which automatic deactivation of the internal household plumbing system by the controller is performed to prevent catastrophic flooding of the household.

2. The system of claim 1, wherein the at least one household subsystem is selected from the group consisting of security, exterior plumbing, lighting, HVAC, surveillance, air quality, smoke detection, carbon monoxide detection, and combinations thereof.

3. The system of claim 1, wherein the subsystems are connected with powerline networking technology.

4. The system of claim 1, wherein the subsystems are connected via data cables technology.

5. The system of claim 1, wherein the sensors are connected via wireless communication.

6. A system for managing household subsystems, comprising:
a controller having a microprocessor, a memory, and a power source;
connected to at least one sensor that is constructed and configured to monitor a catastrophic indicator relating to a corresponding at least one household subsystem; wherein one of the at least one household subsystems is an internal household plumbing system and wherein the catastrophic indicator is a flow sensor set to detect flow above about substantially zero flow for a predetermined time period, substantially immediately following which automatic deactivation of the internal household plumbing system by the controller is performed to prevent catastrophic flooding of the household.

7. The system of claim 6, wherein the predetermined time period occurs during a period programmed for non-use.

8. The system of claim 6, wherein the at least one household subsystem is selected from the group consisting of security, exterior plumbing, lighting, HVAC, surveillance, air quality, smoke detection, carbon monoxide detection, and combinations thereof.

9. The system of claim 6, wherein the subsystems are connected with data cables.

10. The system of claim 6, wherein the subsystems are connected via powerline networking technology.

11. The system of claim 6, wherein the sensors are connected via wireless communication.

12. A method for preventing damage from catastrophic failure of household subsystems, comprising:
providing a controller having a microprocessor, a memory, and a power source, the controller being connected to at least one sensor that is constructed and configured to monitor a catastrophic indicator relating to a corresponding at least one household subsystem; wherein one of the at least one household subsystems is an internal household plumbing system and wherein the catastrophic indicator is a flow sensor set to detect flow above about substantially zero for a predetermined time period, substantially immediately following which automatic deactivation of the internal household plumbing system by the controller is performed to prevent catastrophic flooding of the household; monitoring the household subsystem by the controller through the sensors; detecting a flow above about 0.4 gal/min for a predetermined time period; automatically deactivating the household subsystem substantially immediately following the detection of said flow, thereby preventing catastrophe.

13. The method of claim 12, wherein the at least one household subsystem is selected from the group consisting of security, exterior plumbing, lighting, HVAC, surveillance, air quality, smoke detection, carbon monoxide detection, and combinations thereof.

14. The method of claim 12, wherein the subsystems are connected with data cables.

15. The method of claim 12, wherein the subsystems are connected via powerline networking technology.

16. The method of claim 12, wherein the sensors are connected via wireless communication. wherein the predetermined time period occurs during a period programmed for non-use (such as when the user of the household is asleep and/or away from the dwelling either on a daily basis or for prolonged periods of time, such as during a vacation.

17. The method of claim 12, wherein substantially zero flow is flow less than about 0.4 gal/min.

18. A module for preventing damage from catastrophic failure of a household plumbing system, comprising:
a casing, an electrical connection point, a flow sensor, an autoshutoff valve; a water inlet, and a water outlet;
the water valve upstream of the flow sensor; the flow sensor and water valve in electrical connection with the electrical connection point;
the flow sensor set to detect flow above about substantially zero for a predetermined time period, substantially immediately following which a controller signals the water valve to shut down, thereby preventing catastrophic flooding of the household;
the module connectable to the controller having a microprocessor, a memory, and a power source.

19. The method of claim 18, wherein substantially zero flow is flow less than about 0.4 gal/min.
